(19) United States
(12) Patent Application Publication
(10) Pub. No.: US 2006/0067410 A1
(43) Pub. Date: Mar. 30, 2006

(54) Method for encoding and decoding video signals

(76) Inventors: Seung Wook Park, Sungnam-si (KR); Ji Ho Park, Sungnam-si (KR); Byeong Moon Jeon, Sungnam-si (KR)

Correspondence Address: HARNESS, DICKEY & PIERCE, P.L.C., P.O. BOX 8910, RESTON, VA, 20195, US

(21) Appl. No.: 11/231,887

(22) Filed: Sep. 22, 2005

Related U.S. Application Data
(60) Provisional application No. 60/612,181, filed on Sep. 23, 2004.

(30) Foreign Application Priority Data
Feb. 22, 2005 (KR) 10-2005-0014378

(51) Int. Cl. H04N 11/02; H04N 11/04; H04N 7/12; H04B 1/66

(52) U.S. Cl. 375/240.25; 375/240.01

(57) ABSTRACT

In one embodiment, frame intervals of encoded frames represented by the encoded video signal are decoded, and at least one frame interval includes a different number of encoded frames as compared to another frame interval. Here, associated size information for each frame interval in the encoded video signal may be obtained, and then each frame interval is decoded based on the obtained associated size information.

### DOMESTIC PRIORITY INFORMATION

This application claims priority under 35 U.S.C. §119 on U.S. provisional application 60/612,181, filed Sep. 23, 2004; the entire contents of which are hereby incorporated by reference.

### BACKGROUND OF THE INVENTION

1. Field of the Invention

The present invention relates to a method for encoding and decoding video signals.

2. Description of the Related Art

A number of standards have been suggested for digitizing video signals. One well-known standard is MPEG, which has been adopted for recording movie content, etc., on recording media such as DVDs and is now in widespread use. Another standard is H.264, which is expected to be used as a standard for high-quality TV broadcast signals in the future.

While IV broadcast signals require high bandwidth, it is difficult to allocate such high bandwidth for the type of wireless transmissions/receptions performed by mobile phones and notebook computers, for example. Thus, video compression standards for use with mobile devices must have high video signal compression efficiencies.

Such mobile devices have a variety of processing and presentation capabilities so that a variety of compressed video data forms must be prepared. This indicates that the same video source must be provided in a variety of forms corresponding to a variety of combinations of variables such as the number of frames transmitted per second, resolution, the number of bits per pixel, etc. This imposes a great burden on content providers.

In view of the above, content providers prepare high-bitrate compressed video data for each source video and perform, when receiving a request from a mobile device, a process of decoding compressed video and encoding it back into video data suited to the video processing capabilities of the mobile device before providing the requested video to the mobile device. However, this method entails a transcoding procedure including decoding and encoding processes, and causes some time delay in providing the requested data to the mobile device. The transcoding procedure also requires complex hardware and algorithms to cope with the wide variety of target encoding formats.

A Scalable Video Codec (SVC) has been developed in an attempt to overcome these problems. This scheme encodes video into a sequence of pictures with the highest image quality while ensuring that part of the encoded picture sequence (specifically, a partial sequence of frames intermittently selected from the total sequence of frames) can be used to represent the video with a low image quality.

Motion Compensated Temporal Filtering (MCTF) is an encoding scheme that has been suggested for use in the scalable video codec. However, the MCTF scheme requires a high compression efficiency (i.e., a high coding rate) for reducing the number of bits transmitted per second since it is highly likely that it will be applied to mobile communication where-bandwidth is limited, as described above.

The conventional MCTF scheme encodes an original video sequence in units of frame intervals, each composed of a specific number of video frames, into L (Low-passed) frames containing concentrated energy and H (High-passed) frames having image difference values using temporal correlation between the frames. An important factor in increasing the coding gain of MCTF is whether or not the use of the temporal correlation between frames in the input video sequence is maximized. The overall coding gain is reduced if weakly correlated frames are present in a frame interval.

### SUMMARY OF THE INVENTION

The present invention relates to encoding and decoding a video signal by motion compensated temporal filtering (MCTF).

In an embodiment of the method of decoding a video signal by inverse MCTF, frame intervals of encoded frames represented by the encoded video signal are decoded, and at least one frame interval includes a different number of encoded frames as compared to another frame interval. Here, associated size information for each frame interval in the encoded video signal may be obtained, and then each frame interval is decoded based on the obtained associated size information.

In another embodiment, size information for a current group of frames in an encoded video signal is obtained from the encoded video signal, and frames in the current group of frames are decoded based on the obtained size information.

In one embodiment of the method of encoding a video signal by MCTF, frame intervals are created from frames represented by the video signal, and at least one frame interval includes a different number of frames as compared to another frame interval. Then, the frame intervals are encoded. For example, in one embodiment, the frame intervals are created based on temporal correlation between the frames.

In one embodiment, the frame intervals are created by changing a number of frames in a current frame interval such that the current frame interval includes a different number of frames as compared to another frame interval.

In another embodiment, the frame intervals are created by dividing a current frame interval into two or more frame intervals such that at least one of the divided frame intervals includes a different number of frames as compared to another frame interval.

In a further embodiment, frames represented by the video signal are encoded on a frame interval basis, and at least one frame interval includes a different number of frames as compared to another frame interval.

In yet another embodiment of the method of encoding a video signal by MCTF according to the present invention, size information is added to the encoded video signal. The size information indicates a size of each frame interval in the encoded video signal. For example, an indicator is added to a header of each frame interval, and the indicator indicates a number of frames in the frame interval. As another example, a difference value is added to a header of each frame interval, and the difference value indicates a difference between a fixed number of frames and the number of frames in the frame interval.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram of a video signal encoding device to which a scalable video signal compression method according to the present invention is applied;

FIG. 2 is a block diagram of a filter that performs video estimation/prediction and update operations in the MCTF encoder shown in FIG. 1;

FIG. 3 illustrates a general 5/3 tap MCTF encoding procedure;

FIG. 4 illustrates a 5/3 tap MCTF encoding procedure according to an embodiment of the present invention;

FIG. 5 is a block diagram of a device for decoding a data stream, encoded by the device of FIG. 1, according to an example embodiments of the present invention; and

FIG. 6 is a block diagram of an inverse filter that performs inverse estimation/prediction and update operations in the MCTF decoder shown in FIG. 5 according to an example embodiments of the present invention.

### DETAILED DESCRIPTION OF EXAMPLE EMBODIMENTS

Example embodiments of the present invention will now be described in detail with reference to the accompanying drawings.

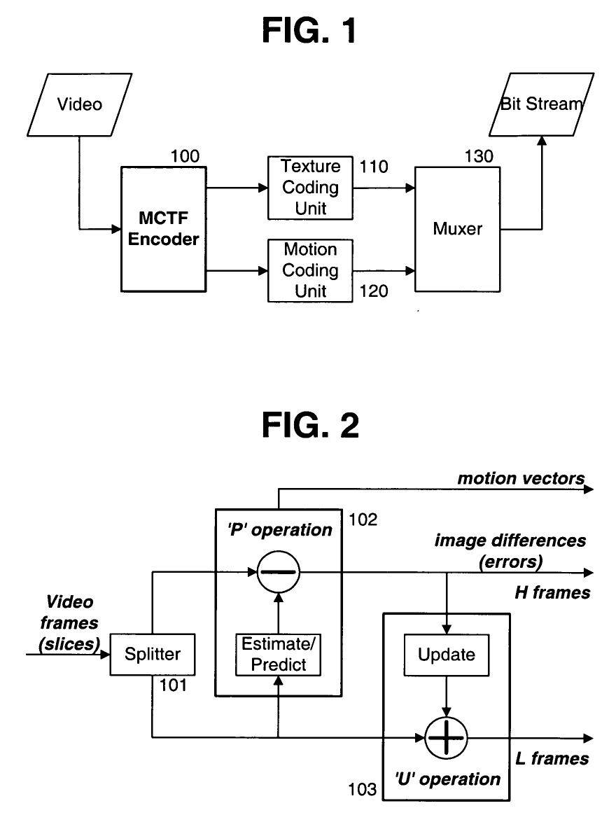

FIG. 1 is a block diagram of a video signal encoding device to which a scalable video signal compression method according to the present invention is applied.

The video signal encoding device shown in FIG. 1 comprises an MCTF encoder 100, a texture coding unit 110, a motion coding unit 120, and a muxer (or multiplexer) 130. The MCTF encoder 100 encodes an input video signal in units of macroblocks in an MCTF scheme, and generates suitable management information. The texture coding unit 110 converts data of encoded macroblocks into a compressed bitstream. The motion coding unit 120 codes motion vectors of image blocks obtained by the MCTF encoder 100 into a compressed bitstream according to a specified scheme. The muxer 130 encapsulates the output data of the texture coding unit 1 10 and the output vector data of the motion coding unit 120 into a set format. The muxer 130 multiplexes the encapsulated data into a set transmission format and outputs a data stream.

The MCTF encoder 100 performs motion estimation and prediction operations on each macroblock of a video frame, and also performs an update operation in such a manner that an image difference of the macroblock from a corresponding macroblock in a neighbor frame is added to the corresponding macroblock. FIG. 2 is a block diagram of a filter for carrying out these operations.

As shown in FIG. 2, the filter includes a splitter 101, an estimator/predictor 102, and an updater 103. The splitter 101 splits an input video frame sequence into earlier and later frames in pairs of successive frames (for example, into odd and even frames). The estimator/predictor 102 performs motion estimation and/or prediction operations on each macroblock in an arbitrary frame in the frame sequence. As described in more detail below, the estimator/predictor 102 searches for a reference block of each macroblock of the arbitrary frame in neighbor frames prior to and/or subsequent to the arbitrary frame and calculates an image difference (i.e., a pixel-to-pixel difference) of each macroblock from the reference block and a motion vector between each macroblock and the reference block. The updater 103 performs an update operation on a macroblock, whose reference block has been found, by normalizing the calculated image difference of the macroblock from the reference block and adding the normalized difference to the reference block. The operation carried out by the updater 103 is referred to as a ‘U’ operation, and a frame produced by the ‘U’ operation is referred to as an ‘L’ (low) frame.

The filter of FIG. 2 may perform its operations on a plurality of slices simultaneously and in parallel, which are produced by dividing a single frame, instead of performing its operations in units of frames. In the following description of the embodiments, the term ‘frame’ is used in a broad sense to include a ‘slice’.

The estimator/predictor 102 divides each of the input video frames into macroblocks of a set size. For each macroblock, the estimator/predictor 102 searches for a block, whose image is most similar to that of each divided macroblock, in neighbor frames prior to and/or subsequent to the input video frame. That is, the estimator/predictor 102 searches for a macroblock having the highest temporal correlation with the target macroblock. A block having the most similar image to a target image block has the smallest image difference from the target image block. The image difference of two image blocks is defined, for example, as the sum or average of pixel-to-pixel differences of the two image blocks. Accordingly, of macroblocks in a previous/next neighbor frame having a threshold pixel-to-pixel difference sum (or average) or less from a target macroblock in the current frame, a macroblock having the smallest difference sum (or average) from the target macroblock is referred to as a reference block. For each macroblock of a current frame, two reference blocks may be present in two frames prior to and subsequent to the current frame, or in one frame prior and one frame subsequent to the current frame.

If the reference block is found, the estimator/predictor 102 calculates and outputs a motion vector from the current block to the reference block, and also calculates and outputs differences of pixel values of the current block from pixel values of the reference block, which may be present in either the prior frame or the subsequent frame. Alternatively, the estimator/calculator 102 calculates and outputs differences of pixel values of the current block from average pixel values of two reference blocks, which may be present in the prior and subsequent frames.

Such an operation of the estimator/predictor 102 is referred to as a ‘P’ operation. A frame having an image difference, which the estimator/predictor 102 produces via the P operation, is referred to as an ‘H’ (high) frame since this frame has high frequency components of the video signal.

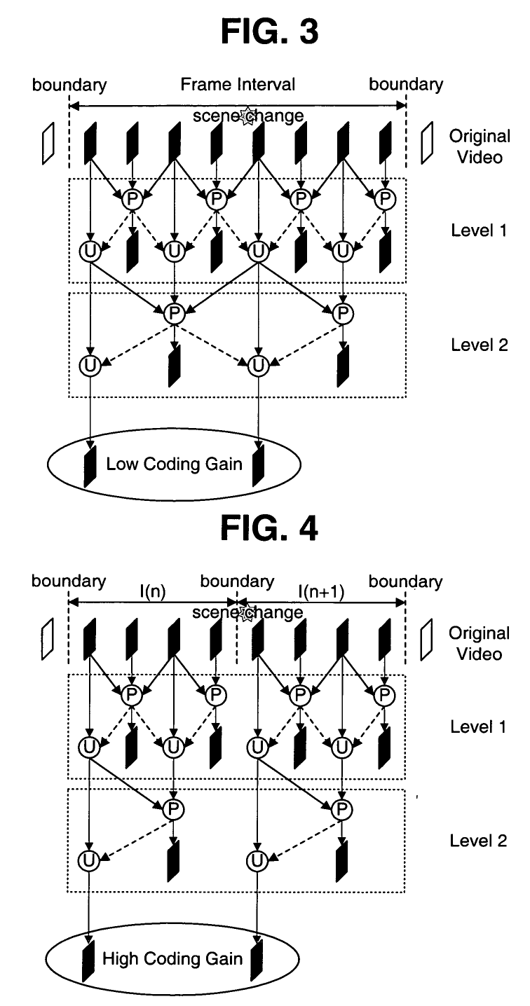

FIG. 3 illustrates a general 5/3 tap MCTF encoding procedure. The general MCTF encoder performs the ‘P’ and ‘U’ operations described above over a plurality of levels in units of specific video frame intervals, each composed of a fixed number of frames. Specifically, the general MCTF encoder generates H and L frames of the first level by performing the ‘P’ and ‘U’ operations on a fixed number of frames in a current video frame interval, and then generates H and L frames of the second level by repeating the ‘P’ and ‘U’ operations on the generated L frames of the first level via an estimator/predictor and an updater at a next serially-connected level (i.e., the second level) (not shown).

Since all L frames generated at each level are used to generate L and H frames of a next level, only H frames remain at every level other than the last level, where L frame(s) and H frame(s) remain.

The ‘P’ and ‘U’ operations may be repeated up to a level at such that one H frame and one L frame remains. The last level at which the ‘P’ and ‘U’ operations are performed is determined based on the total number of frames in the video frame interval. Optionally, the MCTF encoder may repeat the ‘P’ and ‘U’ operations up to a level at which two H frames and two L frames remain or up to its previous level.

If a scene change occurs between frames in the current video frame interval as shown in FIG. 3 (e.g., if an event of lighting a lamp and brightening a dark background occurs), the temporal correlation between frames prior to the occurrence of the scene change and frames subsequent thereto is reduced. While the ‘P’ and ‘U’ operations are performed over a number of levels, frames after the scene change (e.g., after the lamp is lit) exert influence on frames prior to the scene change (e.g., before the lamp is lit). If a video frame interval including frames having such a low temporal correlation is encoded, the H frames have large image difference values and the L frames are updated by the H frame having large image difference values. As a result, the energy contained in the L and H frames is increased and a reduction in the coding gain occurs.

The input video frame sequence is generally encoded in units of video frame intervals, each composed of a fixed number (e.g., 8) frames. However, the MCTF encoding procedure according to the present invention creates frame intervals potentially having different numbers of frames such that the frames in a frame interval may be more highly correlated than if the fixed sized frame intervals were used.

FIG. 4 illustrates a 5/3 tap MCTF encoding procedure according to an embodiment of the present invention. This encoding procedure may be implemented, for example, in the MCTF encoder 100 of FIG. 1. In the example of FIG. 4, the size of a current frame interval is changed to create more highly correlated frame intervals. Namely, as will be described in detail below, a current frame interval of eight frames is divided into two frame intervals, each of four frames. However, it will be understood from the description that the present invention is not limited to dividing a current frame interval into equal sized frames, or limited to dividing a current frame interval into only two frame intervals. Furthermore, instead of changing the size of a current frame interval, the frame intervals of different sizes may be created directly from the input frame sequence.

Returning to FIG. 4, FIG. 4 illustrates that a scene change (e.g., lighting a lamp) occurs between a fourth frame and a fifth frame of a group of eight frames (e.g., a current frame interval). The correlation between the first four frames and the last four frames of this group of eight frames is, therefore, reduced. According to this embodiment of the present invention, highly correlated frames are grouped into separate video frame intervals. Namely, the first four frames are encoded as one video frame interval I(n) and the last four frames are encoded as another video frame interval I(n+1) in the example of FIG. 4.

That is, video frame intervals are encoded according to an MCTF scheme after the sizes of the video frame intervals are changed such that each video frame interval is composed of only frames having a high temporal correlation, thereby increasing the coding gain.

Also when a data stream encoded according to the MCTF scheme is decoded, decoding must be performed in units of groups of L and H frames generated by encoding video frame intervals. Thus, the decoder must be informed of the size (i.e., the total number of frames) of each of the video frame intervals used in the encoding.

To accomplish this, the MCTF encoder 100 according to the encoding scheme of this embodiment of the present invention records a ‘size’ information field in a header area of a group of frames (hereinafter also referred to as a group of pictures (GOP)) generated by encoding a video frame interval. Namely, the ‘size’ information field is added to the encoded video signal. The ‘size’ information field indicates the size (e.g., the total number of frames) of the video frame interval used in the encoding.

The ‘size’ information field may directly indicate the total size (i.e., number) of frames in the video frame interval and/or may indicate only the size difference (size_diff) of the video frame interval from a fixed video frame interval size (size_fixed). Here, the size of the video frame interval is equal to the sum of the fixed size and the size difference of the video frame interval (i.e., size=size_fixed−size_diff). For example, if the fixed video frame interval size is ‘16’ and the size of the created video frame interval is ‘8’, then ‘8’ is recorded in a ‘size_diff’ information field in a header area of a group of frames (GOP) generated by encoding the created video frame interval and ‘16’ is recorded in a ‘size_fixed’ information field in a header area of an upper layer formed by combining a plurality of GOPs. If only the “size_diff” information is recorded (e.g., added) to the video stream, it is possible to decrease the size of the GOP headers.

The data stream encoded in the method described above is transmitted by wire or wirelessly to a decoding device or is delivered via recording media. The decoding device restores the original video signal of the encoded data stream according to the method described below.

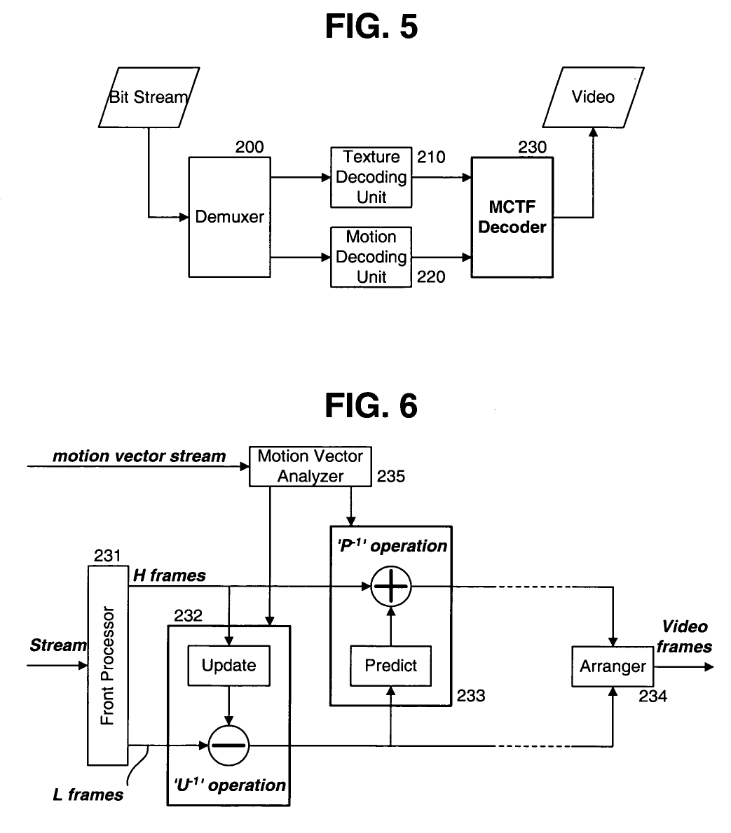

FIG. 5 is a block diagram of a device for decoding a data stream encoded by the device of FIG. 1. The decoding device of FIG. 5 includes a demuxer (or demultiplexer) 200, a texture decoding unit 210, a motion decoding unit 220, and an MCTF decoder 230. The demuxer 200 separates a received data stream into a compressed motion vector stream and a compressed macroblock information stream. The texture decoding unit 210 restores the compressed macroblock information stream to its original uncompressed state. The motion decoding unit 220 restores the compressed motion vector stream to its original uncompressed state. The MCTF decoder 230 converts the uncompressed macroblock information stream and the uncompressed motion vector stream back to an original video signal according to an MCTF scheme.

The MCTF decoder 230 includes, as an internal element, an inverse filter as shown in FIG. 6 for restoring an input stream to its original frame sequence.

The inverse filter of FIG. 6 includes a front processor 231, an inverse updater 232, an inverse predictor 233, an arranger 234, and a motion vector analyzer 235. The front processor 231 divides an input stream into H frames and L frames, and analyzes information in each header in the stream. The inverse updater 232 subtracts pixel difference values of input H frames from corresponding pixel values of input L frames. The inverse predictor 233 restores input H frames to frames having original images using the H frames and the L frames from which the image differences of the H frames have been subtracted. The arranger 234 interleaves the frames, completed by the inverse predictor 233, between the L frames output from the inverse updater 232, thereby producing a normal video frame sequence. The motion vector analyzer 235 decodes an input motion vector stream into motion vector information of each block and provides the motion vector information to the inverse updater 232 and the inverse predictor 233. Although one inverse updater 232 and one inverse predictor 233 are illustrated above, a plurality of inverse updaters 232 and a plurality of inverse predictors 233 are provided upstream of the arranger 234 in multiple stages corresponding to the MCTF encoding levels described above.

The front processor 231 analyzes and divides an input stream into an L frame sequence and an H frame sequence. In addition, the front processor 231 uses information in each header in the stream to notify the inverse updater 232 and the inverse predictor 233 of which frame or frames have been used to produce macroblocks in the H frame.

Particularly, the front processor 231 confirms the value of a ‘size’ information field included in a header area of a current GOP (e.g., current frame interval) in the input stream, and provides the size of the current GOP or the number of frames to be generated by decoding frames in the current GOP to the inverse updater 232, the inverse predictor 233, and the arranger 234.

In another embodiment, the front processor 231 confirms a ‘size_fixed’ information field value included in a header area of an upper layer formed by combining a plurality of GOPs in the input stream. The front processor 231 then subtracts a ‘size_diff’ information field value included in a header area of a current GOP (e.g., current frame interval) from the confirmed ‘size_fixed’ information field value (i.e., size_fixed−size_diff) to obtain the size of the current GOP. The front processor 231 provides the size of the current GOP (e.g., the number of frames to be generated by decoding frames in the current GOP) to the inverse updater 232, the inverse predictor 233, and the arranger 234. Also, if the ‘fixed_size’ information is known and not part of the input data stream, the ‘size_diff’ information is subtracted from this known fixed size to obtain the size of the current GOP.

The inverse updater 232 performs the operation of subtracting an image difference of an input H frame from an input L frame in the following manner. For each macroblock in the input H frame, the inverse updater 232 confirms a reference block present in an L frame prior to or subsequent to the H frame or two reference blocks present in two L frames prior to and subsequent to the H frame, using a motion vector provided from the motion vector analyzer 235, and performs the operation of subtracting pixel difference values of the macroblock of the input H frame from pixel values of the confirmed one or two reference blocks.

The inverse predictor 233 may restore an original image of each macroblock of the input H frame by adding the pixel values of the reference block, from which the image difference of the macroblock has been subtracted in the inverse updater 232, to the pixel difference values of the macroblock.

If the macroblocks of an H frame are restored to their original images by performing the inverse update and prediction operations on the H frame in specific units (for example, in units of frames or slices) in parallel, the restored macroblocks are combined into a single complete video frame.

The above decoding method restores an MCTF-encoded data stream to a complete video frame sequence. In the case where the estimation/prediction and update operations have been performed for a video frame interval N times (N levels) in the MCTF encoding procedure described above, a video frame sequence with the original image quality is obtained if the inverse estimation/prediction and update operations are performed N times in the MCTF decoding procedure. However, a video frame sequence with a lower image quality and at a lower bitrate is obtained if the inverse estimation/prediction and update operations are performed less than N times. Accordingly, the decoding device is designed to perform inverse estimation/prediction and update operations to the extent suitable for its performance.

The decoding device described above may be incorporated into a mobile communication terminal or the like or into a media player.

As is apparent from the above description, a method for encoding/decoding video signals according to the present invention has advantages in that the sizes of GOPs of a video signal are changed when the video signal is encoded according to a scalable MCTF scheme so as to increase temporal correlation during encoding and thereby increasing coding gain.

Although the example embodiments of the present invention have been disclosed for illustrative purposes, those skilled in the art will appreciate that various modifications, additions and substitutions are possible, without departing from the scope and spirit of the invention.

1. A method of decoding a video signal by inverse motion compensated temporal filtering (MCTF), comprising:
decoding frame intervals of encoded frames represented by the encoded video signal, at least one frame interval including a different number of encoded frames as compared to another frame interval.

2. The method of claim 1, further comprising:
obtaining associated size information for each frame interval in the encoded video signal; and wherein
the decoding step decodes each frame interval based on the obtained associated size information.

3. The method of claim 2, wherein the obtained associated size information indicates a size of the associated frame interval.

4. The method of claim 2, wherein the obtaining step obtains an indicator in a header of each frame interval, the indicator indicating a number of frames in the frame interval.

5. The method of claim 2, wherein the obtaining step obtains a difference value in a header of each frame interval, the difference value indicating a difference between a fixed number of frames and a number of frames in the frame interval.

6. The method of claim 5, further comprising:
determining a size of the frame interval based on the difference value; and wherein
the decoding step decodes the frame interval based on the determined size.

7. The method of claim 5, wherein the obtaining step obtains information indicating the fixed number of frames from a header of an upper layer formed by combining a plurality of frame intervals.

8. The method of claim 7, further comprising:
determining a size of the frame interval based on the difference value and the fixed number of frames; and wherein
the decoding step decodes the frame interval based on the determined size.

9. A method of decoding a video signal by inverse motion compensated temporal filtering (MCTF), comprising:
obtaining size information for a current group of frames in an encoded video signal from the encoded video signal; and
decoding frames in the current group of frames based on the obtained size information.

10. The method of claim 9, wherein the obtained size information indicates a number of frames in the current group of frames.

11. The method of claim 9, wherein the obtained size information indicates a difference between a fixed number of frames and a number of frames in the current group of frames.

12. The method of claim 9, wherein the obtained size information indicates a difference between a fixed number of frames and a number of frames in the current group of frames and indicates the fixed number of frames.

13. A method of encoding a video signal by motion compensated temporal filtering (MCTF), comprising:
creating frame intervals from frames represented by the video signal, and at least one frame interval including a different number of frames as compared to another frame interval; and
encoding the frame intervals.

14. The method of claim 13, wherein the creating step creates the frame intervals based on temporal correlation between the frames.

15. The method of claim 13, wherein the creating step changes a number of frames in a current frame interval such that the current frame interval includes a different number of frames as compared to another frame interval.

16. The method of claim 13, wherein the creating step divides a current frame interval into two or more frame intervals such that at least one of the divided frame intervals includes a different number of frames as compared to another frame interval.

17. A method of encoding a video signal by motion compensated temporal filtering (MCTF), comprising:
encoding frames represented by the video signal on a frame interval basis, and at least one frame interval including a different number of frames as compared to another frame interval.

18. A method of encoding a video signal by motion compensated temporal filtering (MCTF), comprising:
